(19) United States
(12) Patent Application Publication
(10) Pub. No.: US 2026/0273425 A1
(43) Pub. Date: Sep. 17, 2026

(54) WALL-CLIMBING TOY

(71) Applicant: Yiguang Cai, Shantou (CN)

(72) Inventor: Yiguang Cai, Shantou (CN)

(21) Appl. No.: 19/679,570

(22) Filed: May 15, 2026

(51) Int. Cl. A63H 11/20; A63H 3/46; A63H 31/00; B05B 17/06

(52) U.S. Cl. CPC A63H 11/20; A63H 3/46; A63H 31/00; B05B 17/06

(57) ABSTRACT

A wall-climbing toy is provided, which includes a toy body, a suction mechanism, and a spray mechanism. The toy body includes a shell, a first chassis, a head, a tail, front limbs, and rear limbs, and the suction mechanism is arranged on the first chassis of the toy body; the spray mechanism includes a water tank and an ultrasonic atomizer, a rear end of the water tank is hinged between a center of the pair of front limbs and a front end of the shell, the head is covered over an outside of the water tank, and a rear end of the head is connected to an outer wall at a middle portion of the water tank; a top of the head is provided with a through hole, and a top of the water tank is exposed above the head after passing through the through hole.

### TECHNICAL FIELD

The present disclosure relates to the field of toy technology, and in particular, to a wall-climbing toy.

### BACKGROUND

Various toys are currently available on the market, and in recent years wall-climbing toys capable of adhering to walls and operating upside down on ceilings have emerged. This type of wall-climbing toy relies on a partial vacuum, which means that air is drawn out of the relatively sealed space between the wall-climbing toy and the wall, causing the external atmospheric pressure to be greater than the atmospheric pressure in the relatively sealed space between the wall-climbing toy and the wall. The atmospheric pressure outside the wall-climbing toy presses the wall-climbing toy against the wall, which requires a relatively airtight space to be formed around the sealed portion of the wall-climbing toy. However, existing products have many drawbacks that make it difficult to meet use requirements.

First, the center of gravity is unbalanced and stability is poor. The weight ratio of the head to the tail is unreasonable, and the center of gravity is prone to shift toward the tail, resulting in insufficient adhesion between the head and the wall, air leakage in the suction area, and easy detachment of the toy; moreover, the toy lacks a flexible dynamic center-of-gravity adjustment structure and has poor adaptability.

Second, poor sealing can lead to detachment and air leakage. Flexible sealing tapes are mostly spliced independently, using a single fixing method, and are prone to loosening and falling off after long-term use; the flexible tape cannot deform with the curvature of the wall, resulting in poor adhesion to concave and convex wall surfaces, which exacerbates air leakage.

Third, the drive mechanism has poor heat dissipation and a short service life. The motor is installed in a confined space, and heat cannot be dissipated in a timely manner, which can easily cause burnout and stalling, shorten the continuous operation time and the service life of the toy, and also lead to fluctuations in suction force.

Fourth, interference occurs between the drive mechanism and the sealing structure, resulting in poor crawling. The flexible tapes can easily obstruct the drive wheels, thereby affecting driving force and steering accuracy; the lack of an effective linkage between the front and rear limbs and the drive mechanism makes the toy prone to suspension and instability on uneven walls.

The technical problem to be solved by the present disclosure is to provide a wall-climbing toy that can dynamically adjust the center-of-gravity distribution of the toy body, improve stability during wall climbing, and effectively avoid damage to the toy caused by long-term use.

### SUMMARY

The objective of the present disclosure is to provide a wall-climbing toy that effectively solves the problems raised in the background art mentioned above.

To achieve the above objective, the present disclosure provides the following technical solution.

A wall-climbing toy comprises: a toy body composed of a shell, a first chassis, a head, a tail, front limbs, and rear limbs, wherein the shell is arranged above the first chassis, a pair of front limbs are connected and hinged between a front end of the shell and a front end of the first chassis, a pair of rear limbs are connected and hinged between a rear end of the shell and a rear end of the first chassis, and the tail is hinged between a center of the pair of rear limbs and a rear end of the shell; wherein the wall-climbing toy further comprises a spray mechanism and a suction mechanism, the spray mechanism comprises a water tank and an ultrasonic atomizer, a rear end of the water tank is hinged between a center of the pair of front limbs and the front end of the shell, the head is sleeved over an outside of the water tank, and a rear end of the head is connected to an outer wall at a middle portion of the water tank; a top of the head is provided with a through hole, and a top of the water tank is exposed above the head after passing through the through hole; a top of the water tank is provided with a water inlet, and a cover plate is provided in the water inlet; an outer end surface of the water tank is provided with a mist outlet, and the mist outlet is oriented in the same direction as a mouth of the head; the ultrasonic atomizer is provided on a bottom surface of the water tank; a total weight of the head, the water tank, the cover plate, and the ultrasonic atomizer is equal to a weight of the tail; and the first chassis is provided with the suction mechanism.

Before use, a small amount of water needs to be added to the water tank. It is only necessary to ensure that the water is in contact with or submerged in the ultrasonic atomizer. Even if a small amount of water is added to the water tank, the total weight of the head, the water tank, the cover plate, the ultrasonic atomizer, and the water is substantially equal to the weight of the tail. Because the rear end of the water tank is hinged between the center of the pair of front limbs and the front end of the shell, the head is covered over the outside of the water tank, and the head is connected to the water tank to form an integral unit, when the wall-climbing toy moves on a vertical wall, ceiling, or inclined wall, the water tank and the head will naturally rotate under the action of gravity and will always keep the center of gravity of the head (and the water tank) offset toward a direction close to the wall. The rotatable spray mechanism is connected to the head, which can increase the weight of the head of the wall-climbing toy. Together with the rotation of the tail, it can dynamically adjust the distribution of the center of gravity of the toy body, so that the center-of-gravity distribution of the head and tail of the wall-climbing toy is balanced, which facilitates the stability of the wall-climbing toy when climbing walls.

When climbing a wall, the ultrasonic atomizer is powered on, and the water in the water tank is broken into tiny mist particles (several microns to tens of microns in diameter) by high-frequency ultrasonic vibration (usually above 1.7 MHz). The mist particles are sprayed from the mouth of the head through the mist outlet of the water tank, thereby forming a spray effect. When climbing the wall, the weight of the emitted mist is negligible and will not affect the head-to-tail balance of the entire wall-climbing toy.

In some embodiments of the present disclosure, the suction mechanism includes a vacuum chamber, a flexible tape ring, clamping components, an impeller, and a rotary drive device. The first chassis is provided with the vacuum chamber, and a bottom surface of the vacuum chamber is provided with a suction hole that communicates with the vacuum chamber; an outer circumference of a top surface of the vacuum chamber is provided with an upwardly protruding rectangular convex ring, and the clamping components are clamped at four corners of the rectangular convex ring; an outer peripheral wall of the vacuum chamber is provided with an upper half of the flexible tape ring, and a lower half of the flexible tape ring extends downward to below the bottom surface of the vacuum chamber; the lower half of the flexible tape ring is provided with four vertically extending split lines, and the split lines correspond to four corners of the vacuum chamber; the top surface of the vacuum chamber is provided with an air outlet channel that communicates with the vacuum chamber, and the impeller is spaced above the air outlet channel; a rotating shaft of the impeller is connected to a power output end of the rotary drive device for transmission.

In some embodiments of the present disclosure, the rotary drive device includes a vacuum motor, a second chassis, a heat-dissipation gasket, and an elastic four-jaw buckle; the rotating shaft of the impeller is connected to an output end of the vacuum motor for transmission; the vacuum motor is provided with the second chassis, and at least one set of heat-dissipation gaskets is spaced above the second chassis; the heat-dissipation gaskets are fixedly provided on an outer wall of the vacuum motor, and there is a gap between a lower part of the second chassis and an upper part of the impeller; an upper end of the vacuum motor is provided with the elastic four-jaw buckle, and the elastic four-jaw buckle does not contact the heat-dissipation gaskets; the second chassis is uniformly provided with four snap rings in a circumferential direction, and a lower end of the elastic four-jaw buckle is connected to the snap rings; the lower end of the elastic four-jaw buckle and the snap rings are provided with corresponding installation holes; the second chassis is fixedly provided with installation columns, and an upper end of each of the installation columns is clamped to a corresponding installation hole.

In some embodiments of the present disclosure, the rear end of the water tank is provided with a vertically oriented positioning sleeve, the center of the pair of front limbs is provided with a positioning hole, and a positioning column is provided between the front end of the shell and the front end of the first chassis; the positioning sleeve and the positioning hole are sequentially sleeved onto the positioning column from top to bottom. With this arrangement, the rear end of the water tank is hinged between the center of the pair of front limbs and the front end of the shell.

In some embodiments of the present disclosure, the vacuum chamber is rectangular in shape, and an inner wall of the upper half of the flexible tape ring is adhered to the outer peripheral wall of the vacuum chamber through an adhesive layer; an upper edge of the flexible tape ring is flush with an upper edge of the rectangular convex ring.

In some embodiments of the present disclosure, a bottom surface of each of the clamping components is provided with a clamping groove configured to accommodate the upper edge of the flexible tape ring and the upper edge of the rectangular convex ring, and a groove opening of the clamping groove is L-shaped and faces downward, and the clamping groove is clamped on a right-angle corner of the rectangular convex ring.

Each of the aforementioned clamping components presses the upper edge of the flexible tape ring onto the rectangular convex ring through the clamping groove. Combined with the adhesion between the upper half of the flexible tape ring and the outer peripheral wall of the vacuum chamber, a dual fixing structure of clamping and adhesion is formed to prevent the flexible tape ring from falling off and to maintain the sealing function of the vacuum chamber even after long-term use. The split lines of the flexible tape ring correspond to four corners of the vacuum chamber. The lower half of the flexible tape ring is divided into four pieces. When the wall-climbing toy is climbing a wall, the lower half of the flexible tape ring can slightly deform with the curvature of the wall and flexibly adhere to the wall to form a seal, thereby ensuring that the toy body remains sealed while moving. The present disclosure significantly improves the sealing performance and stability of the suction mechanism, enhances the practicality of the wall-climbing toy, and has broad market application prospects through the combination of the flexible tape ring and the clamping components.

In some embodiments of the present disclosure, bottom surfaces of the clamping components are provided with insertion columns, and the insertion columns are provided on an inner side of the clamping groove; the top surface of the vacuum chamber is provided with a plurality of insertion holes that cooperate with the insertion columns, and each insertion column is inserted into a corresponding insertion hole. By inserting the insertion columns into the insertion holes, vertical fixing is formed on the clamping components to prevent the clamping components from falling off the rectangular convex ring due to vibration and friction, ensuring long-term effective clamping of the flexible tape ring by the clamping groove and enhancing the stability of the overall structure.

In some embodiments of the present disclosure, a bottom edge of the shell is provided with pressing rods corresponding to the clamping components, and a lower end surface of each pressing rod is in contact with and cooperates with a top surface of each clamping component. By bringing a lower end surface of the pressing rod of the shell into contact with the top surfaces of the clamping components, and by utilizing the assembly pressure of the shell and the first chassis, a continuous downward pressure is formed on the clamping components, further compressing the fit of the clamping groove with the flexible tape ring and the rectangular convex ring.

In some embodiments of the present disclosure, the wall-climbing toy further includes a front drive mechanism and a rear drive mechanism, wherein the front drive mechanism and the rear drive mechanism are respectively arranged on front and rear sides of the suction mechanism; the front and rear drive mechanisms have the same structure, and both include a gearbox and wheels; the second chassis is provided with a detachable gearbox, and an output shaft of the gearbox is fixedly connected to the wheels; the wheels are provided on an outer side of the flexible tape ring; a lower edge of the flexible tape ring is provided with two arc-shaped notches arranged in a staggered manner, one arc-shaped notch corresponds to a wheel of the front drive mechanism, and the other arc-shaped notch corresponds to a wheel of the rear drive mechanism. The two arc-shaped notches expose the wheels and allow them to directly contact the wall, ensuring that the driving wheels are in full contact with the wall to provide reliable crawling power, while avoiding interference from the flexible tape ring with the rotation of the wheels, thereby improving crawling smoothness and steering accuracy.

In some embodiments of the present disclosure, outer sides of the wheels corresponding to the two arc-shaped notches are respectively rotatably connected to one end of a motion link, wherein the other end of one motion link is rotatably connected to bottoms of the front limbs, the other end of the other motion link is rotatably connected to bottoms of the rear limbs, and the motion link has an arc-shaped curved structure. The motion link has elastic deformation capability and can adaptively adjust its angle according to the curvature of the wall, ensuring that the front limbs and the rear limbs always remain pressed against concave and convex wall surfaces, thereby avoiding instability of the front or rear limbs due to external impact and greatly improving climbing adaptability and dynamic balance capability.

Compared with the prior art, the beneficial effects of the present disclosure are as follows.
(1) The present disclosure can dynamically adjust the center-of-gravity distribution of the toy body, balance the center-of-gravity distribution of the head and tail of the wall-climbing toy, and facilitate the stability of the wall-climbing toy when climbing a wall. The head and the rotatable spray mechanism are designed as an integral unit, the connection structure between the integral unit and the wall-climbing toy is compact and integrated, the spatial layout is optimized, the overall volume is reduced, and the structural compactness is improved, making the toy suitable for use on walls with different tilt angles.
(2) The rotary drive device of the present disclosure is connected to the output end of the vacuum motor through the rotating shaft of the impeller. The vacuum motor is provided with the second chassis, and at least one set of heat-dissipation gaskets is spaced above the second chassis. The heat-dissipation gaskets are fixedly clamped on the outer wall of the vacuum motor, and there is a gap between the lower part of the second chassis and the upper part of the impeller; the upper end of the vacuum motor is provided with the elastic four-jaw buckle, which does not come into contact with the heat-dissipation gaskets; the second chassis is uniformly provided with four snap rings in the circumferential direction. The lower end of the elastic four-jaw buckle is connected to the snap rings, and the lower end of the elastic four-jaw buckle and the snap rings are provided with corresponding installation holes. The second chassis is fixedly provided with the installation columns, and upper ends of the installation columns are fixed in place with the corresponding installation holes. Heat generated by the vacuum motor during operation is efficiently conducted to the second chassis through the heat-dissipation gaskets, and then quickly dissipated to the outside through the snap rings and the elastic four-jaw buckle, thereby significantly reducing the temperature rise of the vacuum motor and extending the continuous operation time. The combined structure of the elastic four-jaw buckle and the snap rings balances installation convenience and connection reliability. At the same time, its elastic deformation characteristics can absorb motor vibration, reduce structural resonance, and further improve the quietness and stability of wall-climbing operation.
(3) The upper half of the flexible tape ring of the present disclosure is a monolithic structure, replacing four independent flexible tapes. The installation of the flexible tape can be reinforced by clamping components to prevent the flexible tape ring from falling off, improving vacuum sealing and suction capacity. Moreover, the split lines of the lower half of the flexible tape ring are formed only at the four corners, which retains deformation adaptability and ensures overall sealing. An integrated flexible sealing tape design is adopted and combined with a plurality of fixing methods to replace traditional spliced flexible tapes, thereby avoiding loosening and falling off during long-term use. At the same time, the flexible tape structure is optimized so that it can flexibly deform with the curvature of the wall surface, ensuring that concave and convex walls can be tightly adhered to, preventing air leakage, and ensuring the suction effect.

### BRIEF DESCRIPTION OF THE DRAWINGS

FIG. 1 is a first schematic diagram of an overall structure provided by the present disclosure.

FIG. 2 is a second schematic diagram of the overall structure provided by the present disclosure.

FIG. 3 is a schematic sectional view of FIG. 1.

FIG. 4 is a schematic structural diagram of a flexible tape ring provided by the present disclosure.

FIG. 5 is a first schematic diagram of a partial structure provided by the present disclosure.

FIG. 6 is a second schematic diagram of the partial structure provided by the present disclosure.

FIG. 7 is a schematic structural diagram of a rotary drive device provided by the present disclosure.

### DESCRIPTION OF EMBODIMENTS

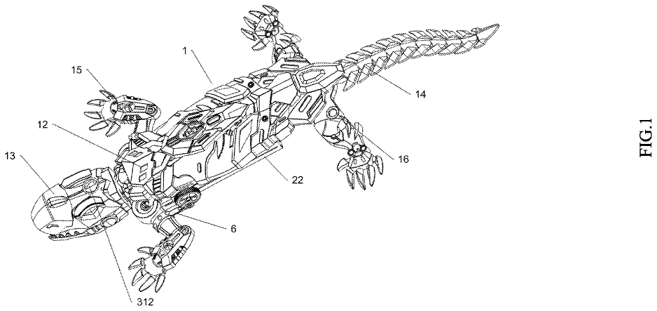

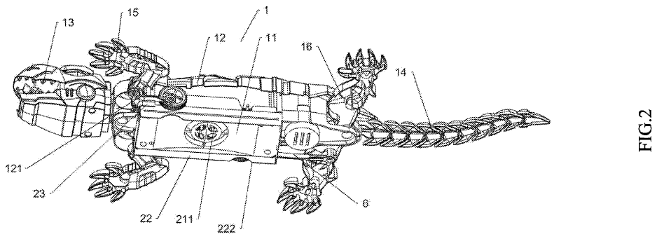

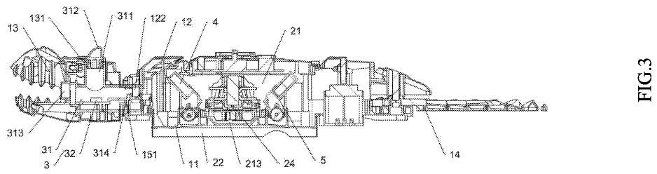

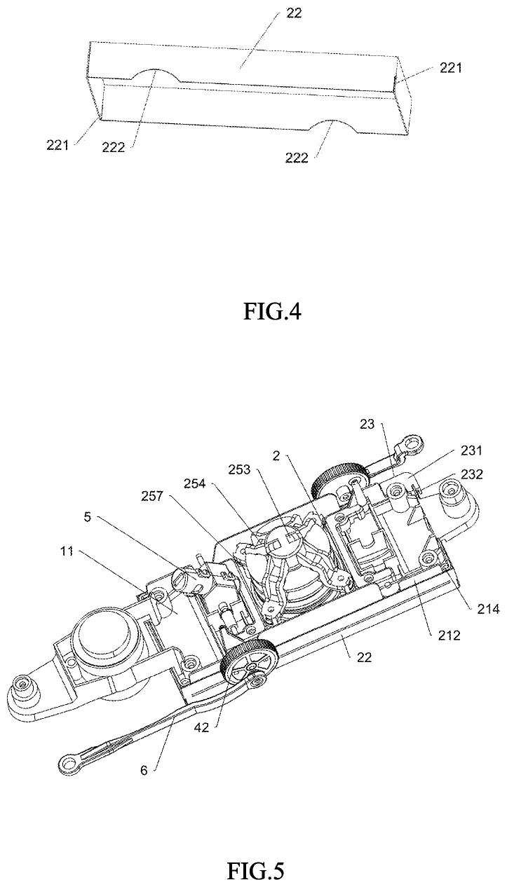

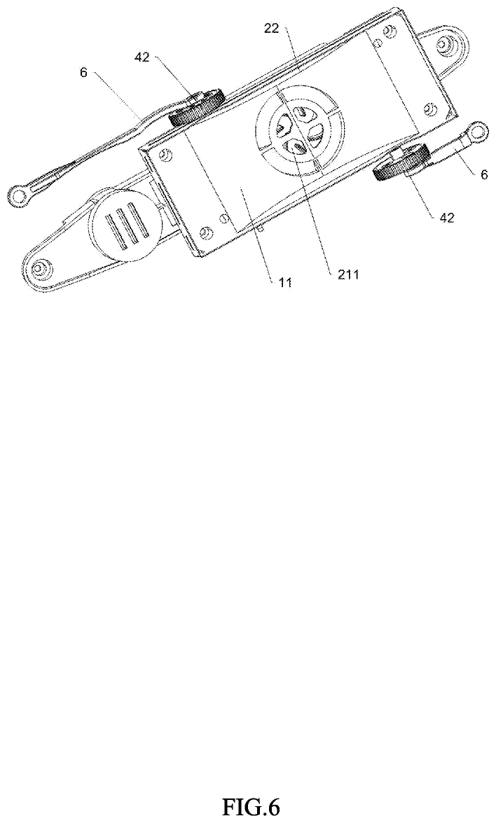

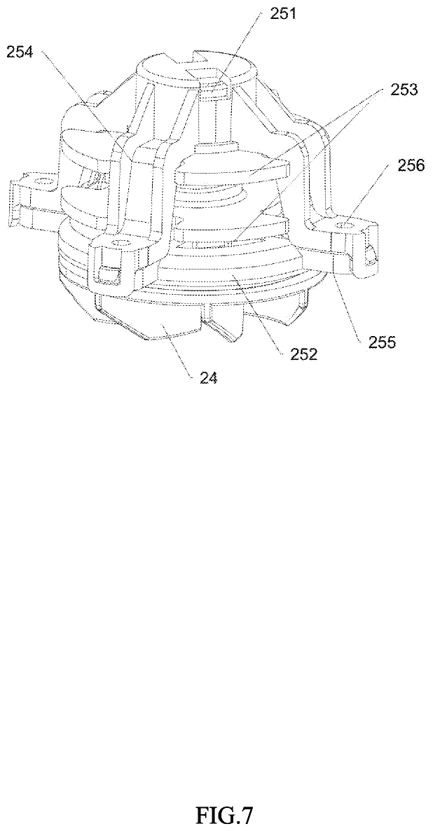

Referring to FIGS. 1-7, a wall-climbing toy provided by the present disclosure includes a toy body 1, a shell 12, a first chassis 11, a head 13, a tail 14, front limbs 15, rear limbs 16, a pressing rod 121, a through hole 131, a positioning column 122, a positioning hole 151, a suction mechanism 2, a vacuum chamber 21, a flexible tape ring 22, clamping components 23, an impeller 24, a suction hole 211, a rectangular convex ring 212, an air outlet channel 213, an insertion hole 214, split lines 221, an arc-shaped notch 222, a clamping groove 231, an insertion column 232, a vacuum motor 251, a second chassis 252, a heat-dissipation gasket 253, an elastic four-jaw buckle 254, snap rings 255, installation holes 256, installation columns 257, a spray mechanism 3, a water tank 31, an ultrasonic atomizer 32, a water inlet 311, a cover plate 312, a mist outlet 313, a positioning sleeve 314, a front drive mechanism 4, a gearbox 41, wheels 42, a rear drive mechanism 5, and a motion link 6.

The technical solutions in the embodiments of the present disclosure are clearly and completely described below with reference to the accompanying drawings. Obviously, the described embodiments are only some, rather than all, of the embodiments of the present disclosure. Based on the embodiments of the present disclosure, all other embodiments obtained by those skilled in the art without creative effort fall within the protection scope of the present disclosure.

In the description of the embodiments of the present disclosure, it should be noted that, unless otherwise specified and limited, the terms “connection” and “installation” should be understood broadly. For example, “connection” may be a detachable connection or a non-detachable connection, and may be a direct connection or an indirect connection through an intermediate medium. In addition, “communication” may be direct communication or indirect communication through an intermediate medium. The term “fixed” means that two elements are connected to each other and maintain the same relative positional relationship after being connected. Directional terms mentioned in the embodiments of the present disclosure, such as “inside”, “outside”, “top”, “bottom”, and the like, refer only to the directions shown in the accompanying drawings. Therefore, the directional terms are used only for better and clearer explanation and understanding of the embodiments of the present disclosure, and do not indicate or imply that the device or component referred to must have a specific orientation or be constructed and operated in a specific orientation. Therefore, they should not be understood as limiting the embodiments of the present disclosure.

The terms used herein do not indicate or imply relative importance or the number of technical features. Thus, features defined by “first” and “second” may explicitly or implicitly include one or more of these features.

Referring to FIGS. 1-7, the wall-climbing toy includes the toy body 1, the suction mechanism 2, and the spray mechanism 3. The toy body 1 is composed of the shell 12, the first chassis 11, the head 13, the tail 14, the front limbs 15, and the rear limbs 16. The shell 12 is arranged above the first chassis 11, a pair of front limbs 15 are connected and hinged between a front end of the shell 12 and a front end of the first chassis 11, a pair of rear limbs 16 are connected and hinged between a rear end of the shell 12 and a rear end of the first chassis 11, the tail 14 is hinged between a center of the pair of rear limbs 16 and the rear end of the shell 12, and the suction mechanism 2 is arranged on the first chassis 11 of the toy body 1; the spray mechanism 3 includes the water tank 31 and the ultrasonic atomizer 32. A rear end of the water tank 31 is hinged between a center of the pair of front limbs 15 and the front end of the shell 12, the head 13 is covered over an outside of the water tank 31, and a rear end of the head 13 is connected to an outer wall at a middle portion of the water tank 31; a top of the head 13 is provided with the through hole 131, and a top of the water tank 31 is exposed above the head 13 after passing through the through hole 131. The top of the water tank 31 is provided with the water inlet 311, and the cover plate 312 is provided in the water inlet 311. An outer end surface of the water tank 31 is provided with the mist outlet 313, and the mist outlet 313 is oriented in the same direction as a mouth of the head 13; the ultrasonic atomizer 32 is provided on a bottom surface of the water tank 31; a total weight of the head 13, the water tank 31, the cover plate 312, and the ultrasonic atomizer 32 is equal to a weight of the tail 14.

Before use, a small amount of water needs to be added to the water tank 31. It is only necessary to ensure that the water is in contact with or submerged in the ultrasonic atomizer 32. Even if a small amount of water is added to the water tank 31, the total weight of the head 13, the water tank 31, the cover plate 312, the ultrasonic atomizer 32, and the water is substantially equal to the weight of the tail 14. Because the rear end of the water tank 31 is hinged between the center of the pair of front limbs 15 and the front end of the shell 12, the head 13 is covered over the outside of the water tank 31, and the head 13 is connected to the water tank 31 to form an integral unit, when the wall-climbing toy moves on a vertical wall, ceiling, or inclined wall, the water tank 31 and the head 13 will naturally rotate under the action of gravity and will always keep the center of gravity of the head 13 (and the water tank 31) offset toward a direction close to the wall. The rotatable spray mechanism 3 is connected to the head 13 as an integral unit, which can increase the weight of the head 13 of the wall-climbing toy. Together with the rotation of the tail 14, it can dynamically adjust the distribution of the center of gravity of the toy body 1, so that the center-of-gravity distribution of the head and tail of the wall-climbing toy is balanced, which facilitates the stability of the wall-climbing toy when climbing walls.

When climbing a wall, the ultrasonic atomizer 32 is powered on, and the water in the water tank 31 is broken into tiny mist particles (several microns to tens of microns in diameter) by high-frequency ultrasonic vibration (usually above 1.7 MHz). The mist particles are sprayed from the mouth of the head 13 through the mist outlet 313 of the water tank 31, thereby forming a spray effect. When climbing the wall, the weight of the emitted mist is negligible and will not affect the head-to-tail balance of the entire wall-climbing toy.

In an implementation, the spray mechanism 3 can be replaced by a miniature projector lamp. As a different form of entertainment, the miniature projector lamp is provided at the position of the water tank 31 in this embodiment. A light path is projected through a mouth opening of the head 13, and the projection changes dynamically according to the factory-set projection content.

The rear end of the water tank 31 is provided with a vertically oriented positioning sleeve 314, and the center of the pair of front limbs 15 is provided with the positioning hole 151. The positioning column 122 is provided between the front end of the shell 12 and the front end of the first chassis 11, and the positioning sleeve 314 and the positioning hole 151 are sequentially sleeved onto the positioning column 122 from top to bottom. By this arrangement, the rear end of the water tank 31 is hinged between the center of the pair of front limbs 15 and the front end of the shell 12.

The suction mechanism 2 includes the vacuum chamber 21, the flexible tape ring 22, four clamping components 23, the impeller 24, and a rotary drive device. The vacuum chamber 21 is provided on the first chassis 11 of the toy body 1, and a bottom surface of the vacuum chamber 21 is provided with the suction hole 211 that communicates with the vacuum chamber 21; the vacuum chamber 21 is rectangular in shape, with an upwardly protruding rectangular convex ring 212 on an outer circumference of a top surface of the vacuum chamber 21. An upper half of the flexible tape ring 22 is attached to the outer wall of the vacuum chamber 21, and an upper edge of the flexible tape ring 22 is flush with an upper edge of the rectangular convex ring 212. A lower half of the flexible tape ring 22 extends downward below the bottom surface of the vacuum chamber 21, and there are four vertically extending split lines 221 on the lower half of the flexible tape ring 22, each split line 221 corresponding to four corners of the vacuum chamber 21; a bottom surface of each clamping component 23 is provided with the clamping groove 231 that can accommodate the upper edge of the flexible tape ring 22 and the upper edge of the rectangular convex ring 212. A groove opening of the clamping groove 231 is arranged downward, and each clamping component 23 is clamped onto a corresponding corner of the rectangular convex ring 212 through the corresponding clamping groove 231. A width of the clamping groove 231 is slightly larger than a total thickness of the upper edge of the rectangular convex ring 212 and the upper edge of the flexible tape ring 22.

Each of the aforementioned clamping components 23 presses the upper edge of the flexible tape ring 22 onto the rectangular convex ring 212 through the clamping groove 231. Combined with the adhesion between the upper half of the flexible tape ring 22 and an outer peripheral wall of the vacuum chamber 21, a dual fixing structure of clamping and adhesion is formed to prevent the flexible tape ring 22 from falling off and to maintain the sealing function of the vacuum chamber 21 even after long-term use. The split lines 221 of the flexible tape ring 22 correspond to four corners of the vacuum chamber 21. The lower half of the flexible tape ring 22 is divided into four pieces. When the wall-climbing toy is climbing a wall, the lower half of the flexible tape ring 22 can slightly deform with the curvature of the wall and flexibly adhere to the wall to form a seal, thereby ensuring that the toy body 1 remains sealed while moving.

The top surface of the vacuum chamber 21 is provided with the air outlet channel 213 that communicates with the vacuum chamber 21. The impeller 24 is spaced above the air outlet channel 213, and the rotary drive device is provided on the first chassis 11. A rotating shaft of the impeller 24 is connected to a power output end of the rotary drive device for transmission. By driving the impeller 24 to rotate through the rotary drive device, the suction hole 211 draws the air below the first chassis 11 into the vacuum chamber 21, and the air in the vacuum chamber 21 is discharged from the air outlet channel 213 under the driving action of the impeller 24, so that the toy body 1 adheres to the wall.

The rotary drive device includes the vacuum motor 251, the second chassis 252, the heat-dissipation gasket 253, and the elastic four-jaw buckle 254. The rotating shaft of the impeller 24 is connected to an output end of the vacuum motor 251 for transmission. The vacuum motor 251 is provided with the second chassis 252, and at least one set of heat-dissipation gaskets 253 is spaced above the second chassis 252. The heat-dissipation gaskets 253 are fixedly clamped on an outer wall of the vacuum motor 251, and there is a gap between a lower part of the second chassis 252 and an upper part of the impeller; an upper fixing cover of the vacuum motor 251 is provided with the elastic four-jaw buckle 254, and the elastic four-jaw buckle 254 does not come into contact with the heat-dissipation gaskets 253; the second chassis 252 is uniformly provided with four snap rings 255 in a circumferential direction. A lower end of the elastic four-jaw buckle 254 is connected to the snap rings 255, and the lower end of the elastic four-jaw buckle 254 and the snap rings 255 are provided with corresponding installation holes 256. The second chassis 252 is fixedly provided with the installation columns 257, and an upper end of each of the installation columns 257 is fixed to a corresponding installation hole 256. The four jaw ends of the elastic four-jaw buckle 254 are provided with hook structures, which undergo elastic deformation when engaged. After being embedded in the installation holes 256 of the snap rings 255, the hook structures automatically reset and lock, ensuring a stable connection between the second chassis 252 and the vacuum motor 251, while also ensuring ease of disassembly and assembly and anti-loosening performance under long-term vibration.

Heat generated by the vacuum motor 251 during operation is efficiently conducted to the second chassis 252 through the heat-dissipation gaskets 253, and then quickly dissipated to the outside through the snap rings 255 and the elastic four-jaw buckle 254, thereby significantly reducing the temperature rise of the vacuum motor 251 and extending the continuous operation time. The combined structure of the elastic four-jaw buckle 254 and the snap rings 255 balances installation convenience and connection reliability. At the same time, its elastic deformation characteristics can absorb motor vibration, reduce structural resonance, and further improve the quietness and stability of wall-climbing operation.

In this embodiment, the rotary drive device is provided as one group. If the wall-climbing toy requires greater power or more functions, multiple groups of rotary drive devices can be provided in the first chassis 11, and each group is controlled by an independent circuit. This is not shown in the figures.

The groove opening of the clamping groove 231 is arranged in an L-shape facing downward, and the clamping groove 231 is pressed onto a right-angle corner of the rectangular convex ring 212. By matching the corner shape of the L-shaped clamping groove 231 with the rectangular convex ring 212, each clamping component 23 can be clamped with two edges of the rectangular convex ring 212, enhancing the clamping strength of the clamping components 23 and further improving the installation firmness of the upper half of the flexible tape ring 22.

A bottom surface of each clamping component 23 is provided with the insertion column 232, and the insertion column 232 is located inside the clamping groove 231. The top surface of the vacuum chamber 21 is provided with a plurality of insertion holes 214 that cooperate with the insertion columns 232, and each insertion column 232 is inserted into a corresponding insertion hole 214. By inserting the insertion columns 232 into the insertion holes 214, the clamping components 23 are vertically fixed to prevent them from falling off the rectangular convex ring 212 due to vibration and friction, ensuring long-term effective clamping of the flexible tape ring 22 by the clamping groove 231 and enhancing the stability of the overall structure.

A bottom edge of the shell 12 is provided with four pressing rods 121 corresponding to the clamping components 23, and a lower end surface of each pressing rod 121 is in contact with and fitted to a top surface of each of the clamping components 23. By bringing a lower end surface of the pressing rod 121 of the shell 12 into contact with the top surface of the clamping component 23, and by utilizing the assembly pressure of the shell 12 and the first chassis 11, a continuous downward pressure is formed on the clamping components 23, further compressing the fit of the clamping groove 231 with the flexible tape ring 22 and the rectangular convex ring 212.

An inner wall of the upper half of the flexible tape ring 22 is adhered to the outer peripheral wall of the vacuum chamber 21 through an adhesive layer. By using the adhesive layer to assist in fixing the flexible tape ring 22, the adhesive layer forms a dual fixing structure of radial fit and axial clamping with the clamping groove 231 of the clamping components 23, further reducing a gap between the flexible tape ring 22 and the vacuum chamber 21 and improving the sealing effect; at the same time, it avoids local looseness that may be caused by relying solely on compression and enhances the overall structural integrity.

The wall-climbing toy further includes the front drive mechanism 4 and the rear drive mechanism 5 having the same structure. Both the front drive mechanism 4 and the rear drive mechanism 5 include the gearbox 41 and the wheels 42. The toy body 1 is provided with a detachable gearbox 41, and an output shaft of the gearbox 41 is fixedly connected to the wheels 42. The wheels 42 are located on an outside of the flexible tape ring 22. A lower edge of the flexible tape ring 22 is offset and provided with two arc-shaped notches 222. One arc-shaped notch 222 corresponds to the wheel 42 of the front drive mechanism 4, and the other arc-shaped notch 222 corresponds to the wheel 42 of the rear drive mechanism 5. The two arc-shaped notches 222 expose the wheels 42 and allow them to directly contact the wall, ensuring that the driving wheels fully contact the wall to provide reliable crawling power, while avoiding interference from the flexible tape ring 22 with the rotation of the wheels 42, improving crawling smoothness and steering accuracy. The front drive mechanism 4 and the rear drive mechanism 5 mentioned above are configured to drive the toy body 1 to travel. The gearbox 41 is composed of a worm wheel, a worm gear, and a motor, and drives the wheels 42 to rotate and drive the toy body 1 to travel on the wall through the gearbox 41. When the wheels 42 of the front drive mechanism 4 or the rear drive mechanism 5 stop rotating, the toy body 1 can automatically turn.

The outer sides of the wheels 42 corresponding to the two arc-shaped notches 222 are respectively rotatably connected to one end of the motion link 6. The other end of one motion link 6 is rotatably connected to bottoms of the front limbs 15, and the other end of the other motion link 6 is rotatably connected to bottoms of the rear limbs 16. The motion link 6 has an arc-shaped curved structure. It has elastic deformation capability and can adaptively adjust the angle of the motion link according to the curvature of the wall, ensuring that the front limbs 15 and the rear limbs 16 always remain pressed against concave and convex wall surfaces, thereby avoiding instability of the front or rear limbs due to external impact and greatly improving climbing adaptability and dynamic balance capability.

It is obvious to those skilled in the art that the present disclosure is not limited to the details of the exemplary embodiments described above, and can be implemented in other specific forms without departing from the spirit or essential features of the present disclosure. Therefore, in all respects, the embodiments should be regarded as exemplary and non-limiting, and the scope of the present disclosure is defined by the appended claims rather than the above description. Therefore, it is intended to encompass within the scope of the present disclosure all variations falling within the meaning and scope of equivalents of the claims. Any reference numerals in the claims should not be regarded as limiting the relevant claims.

What is claimed is:

1. A wall-climbing toy, comprising: a toy body composed of a shell, a first chassis, a head, a tail, front limbs, and rear limbs,
wherein the shell is arranged above the first chassis, and a pair of front limbs are connected and hinged between a front end of the shell and a front end of the first chassis,
a pair of rear limbs are connected and hinged between a rear end of the shell and a rear end of the first chassis,
the tail is hinged between a center of the pair of rear limbs and a rear end of the shell,
wherein the wall-climbing toy further comprises a spray mechanism and a suction mechanism,
the spray mechanism comprises a water tank and an ultrasonic atomizer, a rear end of the water tank is hinged between a center of the pair of front limbs and the front end of the shell, the head is sleeved over an outside of the water tank, and a rear end of the head is connected to an outer wall at a middle portion of the water tank; a top of the head is provided with a through hole, and a top of the water tank is exposed above the head after passing through the through hole,
a top of the water tank is provided with a water inlet, and a cover plate is provided in the water inlet,
an outer end surface of the water tank is provided with a mist outlet, and the mist outlet is oriented in the same direction as a mouth of the head,
the ultrasonic atomizer is provided on a bottom surface of the water tank,
a total weight of the head, the water tank, the cover plate, and the ultrasonic atomizer is equal to a weight of the tail, and
the first chassis is provided with the suction mechanism.

2. The wall-climbing toy according to claim 1, wherein the suction mechanism comprises a vacuum chamber, a flexible tape ring, clamping components, an impeller, and a rotary drive device,
wherein the first chassis is provided with the vacuum chamber, and a bottom surface of the vacuum chamber is provided with a suction hole that communicates with the vacuum chamber; an outer circumference of a top surface of the vacuum chamber is provided with an upwardly protruding rectangular convex ring, and the clamping components are clamped at four corners of the rectangular convex ring,
an outer peripheral wall of the vacuum chamber is provided with an upper half of the flexible tape ring, and a lower half of the flexible tape ring extends downward to below the bottom surface of the vacuum chamber,
the lower half of the flexible tape ring is provided with four vertically extending split lines, and the split lines correspond to four corners of the vacuum chamber,
the top surface of the vacuum chamber is provided with an air outlet channel that communicates with the vacuum chamber, and the impeller is spaced above the air outlet channel, and
a rotating shaft of the impeller is connected to a power output end of the rotary drive device for transmission.

3. The wall-climbing toy according to claim 2, wherein the rotary drive device comprises a vacuum motor, a second chassis, a heat-dissipation gasket, and an elastic four-jaw buckle,
the rotating shaft of the impeller is connected to an output end of the vacuum motor for transmission,
the vacuum motor is provided with the second chassis, and at least one set of heat-dissipation gaskets is spaced above the second chassis;
the heat-dissipation gaskets are fixedly provided on an outer wall of the vacuum motor, and there is a gap between a lower part of the second chassis and an upper part of the impeller;
an upper end of the vacuum motor is provided with the elastic four-jaw buckle, and the elastic four-jaw buckle does not contact the heat-dissipation gaskets;
the second chassis is uniformly provided with four snap rings in a circumferential direction, and a lower end of the elastic four-jaw buckle is connected to the snap rings;
the lower end of the elastic four-jaw buckle and the snap rings are provided with corresponding installation holes;
the second chassis is fixedly provided with installation columns, and an upper end of each of the installation columns is clamped to a corresponding installation hole.

4. The wall-climbing toy according to claim 3, wherein the rear end of the water tank is provided with a vertically oriented positioning sleeve, the center of the pair of front limbs is provided with a positioning hole, and a positioning column is provided between the front end of the shell and the front end of the first chassis; the positioning sleeve and the positioning hole are sequentially sleeved onto the positioning column from top to bottom.

5. The wall-climbing toy according to claim 3, wherein the vacuum chamber is rectangular in shape, and an inner wall of the upper half of the flexible tape ring is adhered to the outer peripheral wall of the vacuum chamber through an adhesive layer;
an upper edge of the flexible tape ring is flush with an upper edge of the rectangular convex ring.

6. The wall-climbing toy according to claim 5, wherein a bottom surface of each of the clamping components is provided with a clamping groove configured to accommodate the upper edge of the flexible tape ring and the upper edge of the rectangular convex ring, and a groove opening of the clamping groove is L-shaped and faces downward, and the clamping groove is clamped on a right-angle corner of the rectangular convex ring.

7. The wall-climbing toy according to claim 6, wherein bottom surfaces of the clamping components are provided with insertion columns, and the insertion columns are provided on an inner side of the clamping groove; the top surface of the vacuum chamber is provided with a plurality of insertion holes that cooperate with the insertion columns, and each insertion column is inserted into a corresponding insertion hole.

8. The wall-climbing toy according to claim 7, wherein a bottom edge of the shell is provided with pressing rods corresponding to the clamping components, and a lower end surface of each pressing rod is in contact with and cooperates with a top surface of each clamping component.

9. The wall-climbing toy according to claim 8, further comprising a front drive mechanism and a rear drive mechanism,
wherein the front drive mechanism and the rear drive mechanism are respectively arranged on front and rear sides of the suction mechanism; the front and rear drive mechanisms have the same structure, and both comprise a gearbox and wheels;
the second chassis is provided with a detachable gearbox, and an output shaft of the gearbox is fixedly connected to the wheels;
the wheels are provided on an outer side of the flexible tape ring; a lower edge of the flexible tape ring is provided with two arc-shaped notches arranged in a staggered manner, one arc-shaped notch corresponds to a wheel of the front drive mechanism, and the other arc-shaped notch corresponds to a wheel of the rear drive mechanism.

10. The wall-climbing toy according to claim 9, wherein outer sides of the wheels corresponding to the two arc-shaped notches are respectively rotatably connected to one end of a motion link, wherein the other end of one motion link is rotatably connected to bottoms of the front limbs, and the other end of the other motion link is rotatably connected to bottoms of the rear limbs, and the motion link has an arc-shaped curved structure.
